(19) United States
(12) Patent Application Publication
(10) Pub. No.: US 2024/0360368 A1
(43) Pub. Date: Oct. 31, 2024

(54) METHOD AND APPARATUS FOR HEAT RECOVERY FROM CRACKED GAS

(71) Applicant: Lummus Technology LLC, Bloomfield, NJ (US)

(72) Inventors: Richard John JIBB, Monroe, NY (US); Roberto GROPPI, The Hague (NL)

(21) Appl. No.: 18/647,170

(22) Filed: Apr. 26, 2024

Related U.S. Application Data
(60) Provisional application No. 63/498,725, filed on Apr. 27, 2023.

(51) Int. Cl. C10G 9/20; B01J 19/00; B01J 19/24

(52) U.S. Cl. CPC C10G 9/20; B01J 19/0013; B01J 19/243; B01J 19/244; B01J 2219/0009; B01J 2219/00103; B01J 2219/00135; B01J 2219/00157; B01J 2219/00159; C10G 2300/4081

(57) ABSTRACT

A system for recovery of heat from a cracked gas product includes a heat exchanger with one or more coiled tube bundles including a mandrel, tubes wound in concentric layers around the mandrel, and tube sheets. The tubes and tube sheets define one or more tube circuits. A cracked gas product is provided to the heat exchanger and flows on a shell side of the exchanger around an outside of the tubes without a substantial change in direction of the cracked gas product. A feed stream and one or more process streams flow inside the tubes, and more specifically, through separate tube circuits. The feed stream and process streams are heated by indirect heat transfer against the cracked gas product, which enables simultaneous heating of separate fluid streams without a convection section. Related methods for heat recovery are also disclosed.

### BACKGROUND

### Technical Field

The present disclosure is generally directed to devices, systems, and methods for processing cracked gas, and more particularly, but not exclusively, to recovering heat from a cracked gas stream via indirect heat exchange.

### Description of the Related Art

Utilizing the available heat from combustion products in a fired furnace for additional applications in processing systems and methods is generally known. Examples include heating (or preheating) a feed stream or utility streams such as boiler feedwater preheating, dilution steam superheating, high pressure steam superheating, preheating combustion air, and generating steam. Burning fuel generates hot flue gas or combustion products, with the hot flue gas utilized in the convection section to heat various streams, such as to preheat the feed stream and/or to generate steam and/or to pre-heat boiler feed water or other process streams, to recover heat from the residual energy in the fuel for use elsewhere in the system. For example, in a known ethylene furnace system, the convection section is used for heating (or preheating) feed, boiling water to generate steam or to superheat steam, while the reaction products (cracked gas) are cooled against boiling water to generate steam. The arrangement of the convection section may depend on the feedstock to be heated. The heating requirement for pyrolysis of a given feedstock comprises the enthalpy required to vaporize (in the case of liquid feeds) and heat the feedstock, the endothermic heat of reaction for the cracking process and the enthalpy required to heat the cracked gas in the reaction coil. Light feeds, such as ethane, propane, mixtures thereof, and others, require less heating than heavier feeds, such as vacuum gas oil and others.

In recent years, new regulations and policies have been introduced to limit carbon dioxide and other emissions in order to combat the effects of global warming and climate change. In response to these regulations, policies, and other factors, it has been proposed to modify certain cracked gas processing systems and methods to rely on an electric heater that does not burn fuel, or to modify the furnace to burn significantly less fuel (which may be referred to as a “low emission furnace”). Heat recovery from the convection section is not possible in systems with an electric heater because there is no flue gas and therefore no convection section. Alternatively, heat recovery from the convection section of a low emission furnace may not be practical because the amount of heat available for recovery is insufficient to heat the feed stream to the desired temperature, or to generate sufficient steam, among other deficiencies. As a result, alternative systems and methods for exchanging heat have been proposed, but such systems and methods likewise have drawbacks and disadvantages.

For example, in U.S. Pat. No. 4,479,869 to Petterson et al. (“Petterson”), heat exchangers are utilized for preheating feedstock external to a convection section. Petterson appears to further disclose a flexible feed pyrolysis process which exchanges heat with a superheated steam for heating a range of feedstocks with different heating requirements. Steam is generated in a primary quench exchanger and superheated in a convection section of the fired heater. However, similar to the above general summary, Petterson relies on burning fuel to superheat steam, which not only inherently produces emissions, but such heat to superheat steam would not be available with an electric heater or low emission furnace. Further, Petterson appears to disclose generation of steam as an intermediate fluid in a convection section, which decreases thermodynamic efficiency.

In a further example, Publication No. EP4056892A1 to Zellhuber et al. (“Zellhuber '892”) appears to disclose a hybrid method of steam cracking using multiple cracking furnaces comprising both electric and fuel fired units connected to a common heat recovery system. The common heat recovery system may use the steam generated from the quench cooling of the reaction products as the heat recovery medium in some embodiments. Steam generated from quench cooling of the electrically heated reactor can be used to preheat air that is used to reduce the fuel consumption of the fired reactors. Suitable apparatus for performing the heat recovery do not appear to be disclosed in Zellhuber '892. The use of multiple cracking furnaces as well as the use of steam generated by quench cooling as a heat recovery medium increases equipment capital cost and complexity in the system, among other deficiencies.

Publication No. EP4056894A1 to Zellhuber et al. (“Zellhuber '894) appears to disclose a steam cracking arrangement for a system which includes an electric cracking furnace and a quench cooling train with at least three cooling steps whereby the process gas stream (i.e., cracked gas) is cooled against vaporizing water and against a mixture of feed hydrocarbon and process (i.e., dilution) steam. Each “cooling step” of Zellhuber '894 involves a separate heat exchange device. Some embodiments appear to disclose additional cooling steps for the process gas stream against boiler feed water as well as superheating saturated steam in a convection zone. Suitable apparatus for performing the cooling steps are not described in detail. The use of multiple heat exchange devices in the cooling train of Zellhuber '894 downstream of the primary or first quenching step increases equipment count and significantly increases capital and other costs of the system.

Publication No. WO2022069726A1 to Jenne et al. (“Jenne”) appears to disclose concepts for thermal integration of an electrically heated reactor. A preheater is used to heat feed prior to an electrically heatable reactor. The preheater is thermally integrated in the sense that reactor byproducts (mainly methane and hydrogen) from the cracking reaction are used as fuel. The apparatus described is a fired heater separate from the electric heater and essentially provides the same function as the convection section in a conventional fired heater, namely to preheat feed, boiler feed water, and to superheat steam. The radiant duty, which is primarily to heat feed to reaction temperature and to provide the heat of reaction for the steam cracking process, is provided by electrical means. In Jenne, there are still carbon dioxide emissions from the fired heater if the byproducts include carbon containing species such as methane or ethane. Further, the available heat in the cracked gas is used to generate steam, a utility, rather than to directly provide part of the heating duty for the process streams.

Publication No. WO2022034013A1 to Oud et al. (“Oud '013”) appears to describe a shell and tube heat exchanger for use as a transfer line exchanger in a hydrocarbon cracking furnace system. In the method disclosed in Oud '013, a cracked gas flows through straight tubes in a tube side space and a hydrocarbon feed flows outside the straight tubes in the shell side space. An elaborate arrangement of helical baffles around a central collector pipe is used to minimize eddies caused by changes in flow direction of the shell side fluid. A bellows is required to compensate for the differential thermal expansion of the tubes relative to the shell. The helical baffles and bellows increase capital cost of the system, as well as maintenance costs in the event of fouling of the baffles and bellows. The baffles and bellows may also lead to a pressure drop due to the changes in flow direction of the shell side fluid. Further, flowing the cracked gas in the tube side space according to Oud '013 results in a low film heat transfer coefficient (W/m2K) which in turn leads to a relatively large heat transfer surface area required. The straight tubes are very long if a substantial amount of heat is to be recovered from the cracked gas, which further increases the mechanical complexity and cost of such a system.

US20200172814A1 to Oud et al. (“Oud '814”) does not relate to an electrically heated system. Rather, the amount of fuel required in the radiant section is reduced by various means, such as by preheating the combustion air. Using waste heat of the cracked gas in the transfer line exchanger, instead of heating the feedstock in the convection section as in prior art systems, may allow for increases in firebox efficiency. For example, Oud '814 claims that increasing the efficiency of the firebox utilizing the concepts described therein leads to a fuel gas reduction of up to, or even exceeding, approximately 20%. The reduced fuel firing results in a shortfall of the energy needed to preheat the feed streams. To balance the heat input, higher-grade heat (i.e. heat available at higher temperature) is used to preheat the feed in favor of generating steam. The waste heat in the cracked gas is first recovered in a transfer line exchanger by heating up the feedstock or feedstock-diluent mixture before it is sent to the radiant coil. Suitable apparatus for performing the cooling steps are not described. Using the feed stream to initially quench reaction products involves a longer residence time at elevated temperatures, which may not cool products quickly enough or to a low enough temperature to freeze the cracked gas, as is preferred for maximum ethylene production and avoiding undesirable byproducts.

In the above and other examples of known cracked gas systems, devices and methods, carbon dioxide and other harmful emissions may still be present. Further, certain solutions rely on intermediate processing fluids, such as steam, which decreases thermodynamic efficiency. Many of the proposed solutions utilize multiple heat exchangers or heating of one process stream at a time, which increases equipment count and overall costs. Known heat exchangers have straight tubes and cracked gas flowing through the tubes (i.e., in the tubeside space), which leads to large, expensive and mechanically complex designs. For instance, such designs may require baffles and/or bellows, which have the disadvantages described above. These and other factors of known cracked gas systems, devices, and methods have a harmful impact on the environment, decrease efficiency, and lead to an overall lower return on investment.

Accordingly, it would be advantageous to have cracked gas devices, systems, and methods that overcome the deficiencies and disadvantages of known systems and methods.

### BRIEF SUMMARY

The present disclosure is generally directed to recovering heat from a cracked gas stream via indirect heat exchange with a coiled tube bundle. More specifically, devices, systems, and methods are disclosed for recovering heat from a cracked gas stream, such as from a steam cracker, by flowing the cracked gas stream over the external surface of a coiled tube bundle to indirectly exchange heat with one or more of a hydrocarbon feed plus dilution steam, superheating steam, boiler feed water (“BFW”), diathermal oil, or some other product flowing inside the tubes of the coiled tube bundle. The concepts of the disclosure can also be described as devices, systems, and methods for heating one or more feed streams prior to entering a reaction coil of a steam cracker, which are particularly advantageous for use in the absence of (or without using) a convection section. Non-limiting implementations may include when there is no heating via combustion products or limited heat input available from combustion products, such as for an electric steam cracker or electrically heated reactor, or for a low emissions steam cracker. The concepts of the disclosure can also be used as part of a system using a combination of fired heating and electrical heating.

In some examples, a heat exchange apparatus may include a pressure vessel containing one or more coil wound type bundles to define a transfer line exchanger (“TLE”). Each coil wound bundle consists of tubes arranged in multiple tube layers wound around a central mandrel and separated by spacers. The tubes of each coil wound bundle may provide one or more tube circuits with each tube circuit having an inlet end connected to a first tube sheet and an outlet connected to a second tube sheet.

An example system may include a primary TLE having an inlet, such as one or more nozzles, for receiving hot cracked gas. The primary TLE may include one or more coiled tube bundles with the primary TLE receiving the hot cracked gas at a temperature in the range of 500-1400 degrees Celsius (“C”), and more preferably from 500-875 degrees C. In a non-limiting example, the temperature is between and including 700-875 degrees Celsius (“C”). The hot cracked gas is initially quenched in the primary TLE and provided to an outlet of the primary TLE, such as one or more nozzles, for outputting cooled cracked gas from the primary TLE following the initial quench. Some examples of the system contemplate the use of other types of TLEs without a coiled tube bundle as the primary TLE. The inlet(s) and outlet(s) nozzles are preferably oriented parallel to the flow direction of the cracked gas, but in some cases they could have an arrangement other than parallel. The cracked gas flows through and in between layers of the spaced coiled tubes (i.e., around an exterior of the coiled tubes) that comprise the bundles and boiling water or some other quenching fluid flows inside one or more of the tube circuits that comprise each coil wound bundle.

The system may further include a secondary TLE, where the cracked gas received at the secondary TLE may already be quenched and will have a lower temperature than the above. In such examples, the quenched cracked gas heats feed or utility streams via indirect heat transfer. More specifically, the secondary TLE may include one or more coiled tube bundles where the quenched cracked gas flows through and in between layers of the spaced coiled tubes (i.e., around an exterior of the coiled tubes) that comprise the bundles and the feed or utility streams to be heated flow inside the coiled tubes.

An example method of recovering heat may be summarized as including partially cooling a cracked gas product from multiple reactor coils at 700-875 degrees C. (or the temperatures described above) to a temperature in the range of 550-700 degrees C. in a primary TLE (which may also be referred to herein as a “primary heat exchanger”) against boiling water, feeding the cracked effluent to the inlet of a secondary TLE (which may also be referred to herein as a “secondary heat exchanger”) containing coil wound tube bundles with one or more tube circuits, and preheating one or more hydrocarbon feed streams in some of the tube circuits (which may be referred to herein as “process tube circuits”) to a temperature in the range of 450-700 degrees C., and more preferably 500-650 degrees C. and/or process steam (dilution steam), BFW, or diathermal oil streams in other circuits of the tube circuits (which may also be referred to herein as “service tube circuits”). The cracked gas flows through and in between layers of the spaced coiled tubes that comprise the bundles, while fluids to be heated flow inside the one or more tube circuits. In some examples, the primary transfer line exchanger also includes coiled tube bundles for the initial quenching operation.

The concepts of the disclosure allow flexibility to use a single cracked gas product stream to heat one or multiple fluids in parallel within a single coiled bundle containing multiple intertwined tube circuits. In other words, the concepts of the disclosure enable flexibility to define the number and arrangement of tube circuits in the coiled tube bundles, which allows simultaneous heating of multiple fluids against a common cracked gas flow with a single coiled tube bundle. The apparatus may also be configured to heat multiple fluids in two or more coil wound bundles in series in a single shell but also in separate shells in series. There are numerous possibilities for arrangement of the tube circuits, including, without limitation: (i) each process tube circuit being connected to a single reactor coil; (ii) some tube circuits containing balancing dilution steam which may be connected to multiple reactor coils; (iii) some tube circuits superheating steam generated from the quenching of the reaction products; (iv) some tube circuits in a second coiled tube bundle in series with the first coiled tube bundle are used to heat BFW; and (v) some tube circuits in a second coiled tube bundle in series with the first coiled tube bundle being used to heat diathermal oil for further downstream process use, among others.

A further method of using the apparatus involves the combination of fired heaters and electric heaters with a common heat recovery system. For example, the cracked gas product from both the electrical and fired heaters is combined and fed to the inlet(s) of the pressure vessel or secondary TLE. The feed streams to the respective fired heaters can be heated either in a convection section of the fired heaters (using the excess heat from combustion products) or in a tube circuit of the coil wound heat exchanger bundle (or secondary TLE). To balance the heat duty from all of the cracked gas against a portion of the hydrocarbon feed, dilution steam may be preheated and/or steam generated from the quenching of reaction products may be superheated.

Additional features, benefits, and advantages of the concepts of the disclosure will be described in detail with reference to the accompanying drawings, or otherwise appreciated by those of ordinary skill in the relevant art upon a review of the present disclosure.

### BRIEF DESCRIPTION OF THE SEVERAL VIEWS OF THE DRAWINGS

The present disclosure will be more fully understood by reference to the following figures, which are for illustrative purposes only. These non-limiting and non-exhaustive embodiments are described with reference to the following drawings, wherein like labels refer to like parts throughout the various views unless otherwise specified. The particular shapes of the elements as drawn may have been selected for ease of recognition in the drawings. The figures do not describe every aspect of the teachings disclosed herein and do not limit the scope of the claims.

FIG. 1 is a schematic diagram of a heat recovery system with a convection section and a primary transfer line exchanger.

FIG. 2 is a schematic diagram of an embodiment of a heat recovery system with an electrical heater according to the present disclosure.

FIG. 3A is a schematic diagram of the heat recovery system of FIG. 2 with multiple electrical heaters and a common transfer line.

FIG. 3B is schematic plan view of the heat recovery system of FIG. 3A.

FIG. 4A is a schematic illustration of a transfer line exchanger of the heat recovery system of FIG. 2 with a single coiled tube bundle.

FIG. 4B is a schematic illustration of a transfer line exchanger of the heat recovery system of FIG. 2 with multiple coiled tube bundles.

FIG. 4C is a schematic illustration of tube circuits in the transfer line exchanger of FIG. 4B.

FIG. 5 is a schematic diagram of an embodiment of the heat recovery system of FIG. 2 with a primary transfer line exchanger and a secondary transfer line exchanger both including coiled tube bundles.

### DETAILED DESCRIPTION

Persons of ordinary skill in the relevant art will understand that the present disclosure is illustrative only and not in any way limiting. Other embodiments of the presently disclosed systems and methods readily suggest themselves to such skilled persons having the assistance of this disclosure.

Each of the features and teachings disclosed herein can be utilized separately or in conjunction with other features and teachings to provide heat recovery devices, systems, and methods. Representative examples utilizing many of these additional features and teachings, both separately and in combination, are described in further detail with reference to the attached Figures. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense, and are instead taught merely to describe particularly representative examples of the present teachings.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced, but are not intended to limit the dimensions and the shapes shown in the examples in some embodiments. In some embodiments, the dimensions and the shapes of the components shown in the figures are exactly to scale and intended to limit the dimensions and the shapes of the components.

In general, the concepts of the disclosure are useful for heating feed or other processing streams in systems that do not include a convection section or flue gas heat source, such as in systems with an electrically heated steam cracker, or in systems where the heat available in the convection section is limited, such as in a low emission furnace, or a combination of the two, among others. One particular application of the technology may be for the feed heating and/or effluent cooling section (secondary TLE) in the electrically heated furnace designed and developed by Applicant, which is the subject of U.S. Provisional Patent Application No. 63/269,752 filed on Mar. 22, 2022, the entire contents of which are incorporated herein by reference. The concepts of the disclosure are useful for recovering heat from low emissions cracking heaters which burn a minimum amount of fuel to generate heat, but are therefore limited by the amount of heat available to preheat the feed or other streams, such as BFW in a non-limiting example. The concepts of the disclosure reduce costs by combining multiple heating services in a single vessel and utilizing a smaller surface area for heat transfer than would be required by use of straight tubes, while also increasing reliability and reducing maintenance downtime by eliminating the need for bellows as required for straight tube designs. Further, embodiments of the disclosure provide flexibility to simultaneously heat different feeds and/or other streams including BFW, steam, and diathermal oil in separate tube circuits. In some embodiments, cracked gas flows may be mixed prior to further cooling in the secondary TLE, which provides operational benefits relative to mixing cracked gas flows at lower temperatures downstream of the secondary TLE.

Unless the context clearly dictates otherwise, the term “cracked gas” refers to a material stream formed in a thermal pyrolysis cracking system under controlled residence time, temperature profile, and partial pressure. Hydrocarbons in the feedstock are cracked into smaller molecules that are predominantly ethylene, but also include other olefins and diolefins. The resulting product mixtures can vary widely, depending on feedstock and severity of the cracking operation. Co-products (or secondary products) include acetylene aromatics, C4 and C5 fractions and fuel oil, while hydrogen and methane may be used as fuel in the plant, or purified, such as in the case of hydrogen. Unless provided otherwise, the terms “reactor effluent,” “reaction products,” and “product stream” may be used interchangeably with “cracked gas” and have a similar definition to that of “cracked gas” provided above, unless otherwise indicated.

The terms “heater,” “cracking heater,” and steam cracking furnace” may refer to any device for providing one or more of (i) the heat input required to heat and/or vaporize a feedstock, (2) the heat input required to heat the feed from an inlet temperature to an outlet temperature and (iii) the heat input required for an endothermic heat of reaction.

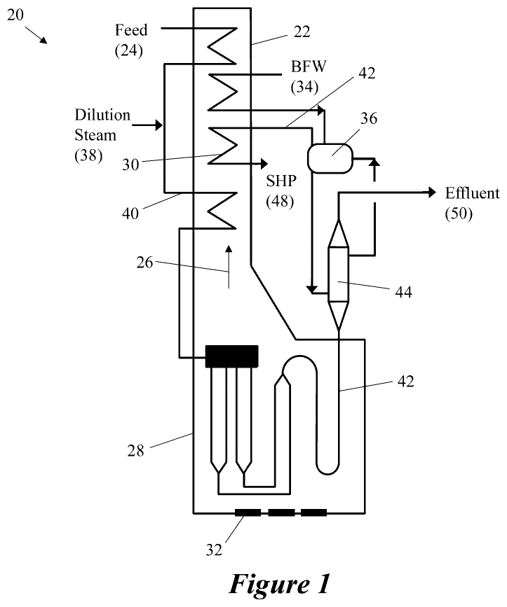

Beginning with FIG. 1, illustrated therein is a schematic diagram of a conventional steam cracking furnace and associated heat recovery system 20 provided to highlight the benefits and advantages of the present disclosure. The heat recovery system 20 includes a convection section 22 that heats all of a feed stream 24 against combustion products, such as flue gas 26 from a radiant section firebox 28. In more detail, the convection section 22 may cooperate with a radiant section firebox 28 to define a furnace. The convection section 22 may include several separate heat exchangers 30 provided in the form of straight tube bundles passing, one or more times, through the convection section 22 that are positioned in the flue gas stream 26 from the radiant section 28. The radiant section 28 may be heated by a plurality of burners 32. The feed stream 24 containing hydrocarbons is provided to the convection section 22, where the feed stream 24 is preheated in one of the heat exchangers 30 in the convection section 22. BFW 34 also passes through one of the heat exchangers 30 of the convection section 22 for preheating. The preheated BFW 34 is then provided to a steam drum 36. Steam 38, which may be dilution steam, from elsewhere in the system 20 may be further heated in one of the heat exchangers 30 in the convection section 22 and combined with feed stream 24. A combined stream 40 of hydrocarbon feed and dilution steam passes through a further heat exchanger 30 of the convection section 22 for additional heating, and is then passed through the radiant section 28 to heat the combined stream 40 to reaction temperature and form a cracked gas stream 42. The cracked gas stream 42 may be immediately quenched, such as in a primary transfer line exchanger 44. The cracked gas stream 42 (or reaction product stream) exiting the radiant section 28 is quenched or cooled against water from the steam drum 36 to generate saturated steam in the primary transfer line exchanger 44 with the saturated steam provided to the steam drum 36. A saturated steam stream 46 is withdrawn from the steam drum 36 and can be further heated (or overheated) in a heat exchanger 30 of the convection section 22 to generate superheated high pressure steam 48 for use elsewhere in the system 20. The primary transfer line exchanger 44 outputs the quenched cracked gas stream 50 as an effluent for further processing. Although not shown in FIG. 1, additional heat exchangers may also be utilized downstream of the primary transfer line exchanger 44 to further cool the quenched cracked gas stream 48.

Conventionally, heat recovery from reactor effluent or cracked gas employs at least one set of single pass shell and tube heat exchangers with straight tubes that are located as first exchangers that the cracked gas enters after the radiant section, and that may be referred to as the primary TLE. The primary TLE initially cools cracked gas flowing inside straight tubes, usually by providing latent heat to vaporize high pressure water. Some systems also use secondary TLEs that are arranged downstream of the primary TLE and may further cool the cracked gas ahead of a downstream water quench tower. The amount of heat recovery possible in the primary and secondary TLEs depends on the difference between the inlet temperature and the outlet temperature for the cracked gas. For the primary TLE, the inlet temperature coincides with the furnace exit temperature and for the secondary TLE, the inlet temperature coincides with the highest allowable outlet temperature from the primary TLE, which in turn depends on the type of feed. The lowest allowed outlet temperature from the TLE is dependent on fouling considerations relative to onset of condensation of heavy components, which will cause deposits that rapidly lead to increases in outlet temperature and pressure drop to a point where the resulting run length or time between cleanings and/or decoking cycles becomes controlled by the TLE operation. For example, the lowest acceptable outlet temperature for typical liquid feeds is ˜360 C because of condensation of heavy components in the cracked gas, and in this case a secondary TLE is typically not used to avoid further condensation in a second TLE. For light hydrocarbon cracking, less primary TLE fouling from condensation results. In that case, multiple TLEs in series may be used, such as a primary TLE generating high-pressure steam and a secondary TLE generating low-pressure steam, preheating feed or other heat recovery duty.

In other words, lighter feeds, such as ethane, result in a reaction product that can be cooled to lower temperatures and therefore contemplate the use of a secondary TLE. Conventional primary TLE designs are discussed in Ullmans Encyclopaedia—“Ullmann's Encyclopaedia of Industrial Chemistry”, 15 Apr. 2009, article “Ethylene,” Section 5.2. It is noted that all of the primary TLE designs from this reference cool reactor effluent (or cracked gas) by flowing the reactor effluent inside essentially straight tubes. Likewise, conventional secondary TLE designs have straight tubes with product gas flowing inside the tubes. The prior art designs have avoided shell side flow of the cracked gas on the outside of straight tubes because the multiple changes in direction can result in stagnant zones, as well as concerns about cleaning and mechanical and metallurgical concerns. As will be explained in more detail below, the concepts of the disclosure replace cracked gas flow inside straight tubes with cracked gas flow on the outside of coiled tubes and through and in between layers of the spaced coiled tubes (i.e., around an exterior of the coiled tubes) in a channel created between concentric layers of coiled tubes and a shell, but without substantial changes in direction to reduce pressure drop, among other benefits.

To reduce emissions from steam cracking furnaces, various approaches are suggested in the known technologies already discussed above. Many of these approaches may result in a reduced amount of fuel fired, which in turn reduces the heat available in a convection section to preheat hydrocarbon feed stream 24. In the case of an electrically heated reactor, there is no flue gas stream 26 available for preheating feed stream 24 and/or preheating BFW 34 and/or generating steam. In such cases, it becomes desirable to minimize or eliminate steam generation (through quenching of reaction products) and to maximize heat recovery from reactor effluent to product feeds. Heat may be transferred between feed stream 24 (or combined steam and feed stream 40) and products in a heat exchanger or between products and an intermediate fluid (such as for example steam or a diathermal oil), and from the intermediate fluid to the feed 24 or other streams to be heated. The preferred heat recovery method is indirect heat exchange to achieve the highest thermodynamic efficiency since an intermediate fluid will inevitably result in lower temperature available to the process streams. In certain configurations, it may be advisable to have intermediate processing fluids, such as to reduce or eliminate fouling or cleaning concerns inside the tubes. Conventional heat exchange methods (or heat recovery methods) only consider exchanging heat between two streams at a time. The concepts of the disclosure provide a method whereby multiple streams can be heated simultaneously (in parallel or in series) by a single common cracked gas effluent stream. In an embodiment, the disclosure also provides a method for directly cooling the cracked gas from a reaction coil or coils against BFW to generate high pressure steam. In an embodiment, the disclosure provides a method for directly cooling the cracked gas from at least one reaction coil to preheat a combination of hydrocarbon feed and dilution steam.

During the development of the embodiments of the disclosure, a study was conducted regarding electric heaters and/or electrically heated reactors. In the study, conventional shell and tube heat exchangers with straight tubes were considered essentially as a replacement for the absent convection section for an electrically heated reactor. There were a number of important observations, including: (1) to achieve a desired inlet temperature to the reactor coil, or crossover temperature (“TXO”), the required tube length for the straight tubes was very long, and the metallurgy of the tubes had to be upgraded to high temperature alloys such as stainless steels, for example SS347H, which drastically increases costs; (2) the long tubes expand upon heating in proportion to their length, and the resultant stresses in the tubes and the tube sheets must be compensated for, such as by using a bellows device and/or using a shell metallurgy with similar thermal expansion properties which also would increase the overall cost; and (3) the above problems could be alleviated by using shorter heat exchangers in series with one exchanger for each feed stream where the exchangers operating at lower temperatures might not require the upgraded metallurgy, but preheating multiple feed streams separately results in a large number of individual heat exchangers with complex piping layouts, which increases costs, and coke particles carried over from the reactor may accumulate in the transition between heat exchangers in series and/or in the piping and manifolds. Even with the above alleviating measures, it appeared evident that using heat exchangers with straight tubes would provide a limit to the maximum TXO achievable and therefore an overall limit to the feasible heat recovery.

As a result, and somewhat surprisingly, it was discovered that using multiple shell and tube heat exchangers with straight tubes to preheat feed can be even more expensive than preheating the feed in a convection section according to conventional methods. Doing the first or initial quench cooling with BFW to generate steam, as in a traditional primary TLE, keeps the metal surfaces cool enough that the heat exchanger tubes don't need to made of expensive high temperature alloys because the metal temperature of the tubes is kept low by the very high heat transfer coefficient of boiling water (latent heat at constant temperature). However, if the reactor effluent is cooled by the feed gas, then the metal surfaces will be much hotter and more expensive materials are required, as above. As a result, the high cost of the prior art conventional shell and tube heat exchangers is due to, at least in part: (A) low heat transfer rates attributable to the cracked gas flowing inside the tubes with a very low allowed pressure drop, which results in a low convective film heat transfer rate and leads to a high surface area requirement for heating, and thus to a large amount of shells (or heat exchangers), along with a higher metal temperature of the tubes; and (B) the use of multiple shells (or heat exchangers) with only one stream heated by each heat exchanger, which limits flexibility and increases equipment count and overall cost.

By contrast, and as further described below, the concepts of the present disclosure address the high cost of recovering heat from cracked gas to preheat feed streams by reducing the total surface area utilized for heating by relying on a higher overall heat transfer coefficient with the same pressure drop, alternatively, or in combination, the higher heat transfer coefficient would allow for a higher TXO against the same effluent inlet temperature. In some embodiments, the overall heat transfer coefficient is higher by a factor of 2-3 times relative to heat exchangers with straight tubes, while maintaining the same (or a similar) pressure drop. Further, the concepts of the present disclosure provide additional flexibility, including enabling heating multiple feeds to multiple reactor coils against a single common cracked gas effluent stream.

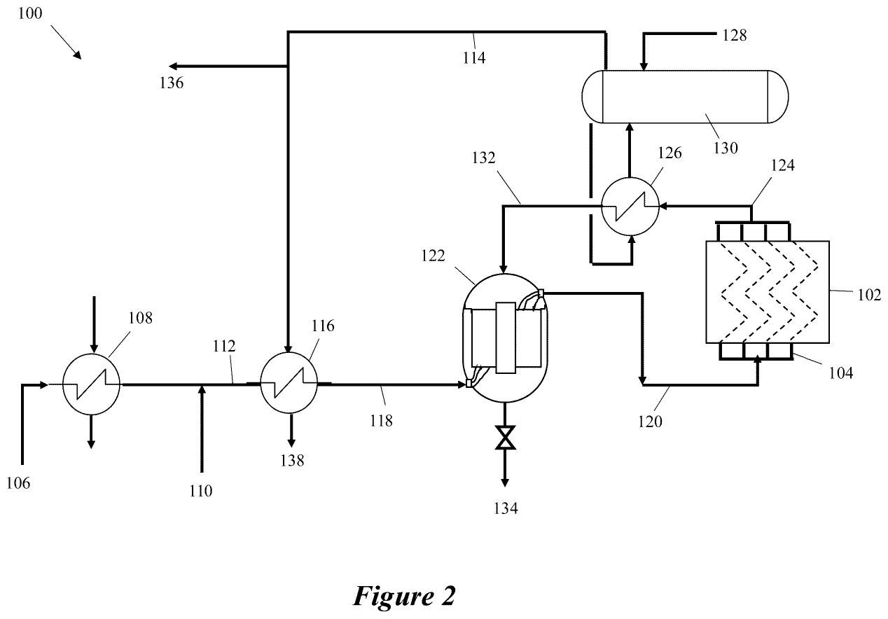

FIG. 2 is a schematic diagram of one or more embodiments of a heat recovery system 100 according to the present disclosure. The system 100 includes an electrically heated furnace 102 (which may also be referred to as an “electrical heater 102”). In one or more embodiments, the system 100 is for a Naphtha feed to a reaction coil 104 in the electrically heated furnace 102, although the concepts of the system 100 and related methods can also be applied to other types of feeds and multiple reaction coils 104 and heated electric furnaces 102. A Naphtha feed 106 is first vaporized in a vaporizer 108 and then mixed with dilution steam 110. The Naphtha dilution steam mixture 112 is then heated against saturated steam 114 in a superheater 116. The heated Naptha dilution steam mixture 118 is fed to one (or more) tube circuits of a coil wound heat exchanger 122 or secondary TLE 122 where it is further heated against reaction products, as further described herein, to produce a further heated Naptha dilution steam mixture 120. A temperature of the further heated Naphtha and dilution steam mixture 120 entering the reaction coil 104 from the secondary TLE 122 is the crossover temperature (“TXO”), and is preferably above 550 degrees C., and more preferably above 600 degrees C. In an embodiment, a range of the TXO is between 500 degrees C. to 650 degrees C., including all intervening and limit values. The TXO shares an inverse relationship with the amount of electrical energy utilized to heat the reaction mixture in the reaction coil 104, or further heated Naphtha steam mixture 120, meaning that a higher TXO reduces the amount of electrical energy used to heat the mixture 120 in the reaction coil 104 to reaction temperature.

The thermal cracking reaction of the further heated mixture 120 is carried out in the reaction coil 104 by the addition of heat from the electrically heated furnace 102 to produce a cracked gas reaction product 124. In an embodiment, the cracked gas reaction product 124 leaving the reactor coil 104 has a temperature in a range of 500-1400 degrees Celsius (“C”), and more preferably from 500-875 degrees C. In a non-limiting example, the temperature is between and including 750 degrees C. to 875 degrees C., including all intervening and limit values. It is generally preferable to “freeze” or rapidly cool the reaction product 124 to preserve the yield of the reaction. Accordingly, the cracked gas reaction product 124 leaving the reaction coil 104 is fed to a primary TLE 126, where it is cooled against pressurized boiler feed water (BFW) 128 from steam drum 130 to generate the high pressure saturated steam 114. The cooling of the reaction products 124 in the primary TLE 126 is preferably by a minimum amount necessary to freeze the reaction and preserve the yield of the reaction in order to preserve heat for use elsewhere in the system 100. In other words, the system 100 contemplates cooling the reaction products 124 to a lesser degree and producing less steam than in conventional systems so that more heat duty remains available for recovery elsewhere in the system.

In one or more embodiments, the reaction products 124 are cooled in the primary TLE 126 to a temperature in the range of 550 degrees C. to 700 degrees C., including all intervening and limit values, to produce quenched reaction products 132 (which may also be referred to herein as “minimally quenched cracked gas 132”). The quenched reaction products 132 are fed to the secondary TLE 122 and cooled against the reactor feed, or Naptha dilution steam mixture 118. Effluent 134 is output from the secondary TLE 122 for further processing. The system 100 may also provide export steam 136 from the steam drum 130 for use elsewhere in the system 100 and output products 138, such as water and/or steam, from the superheater 116 to a condenser for recycle. In this way, the secondary TLE 122 preheats, via indirect heat transfer, the reactor feed (or Naptha dilution steam mixture 118) against residual heat in the cracked gas product 124 without a convection section or without burning significant amounts of fuel.

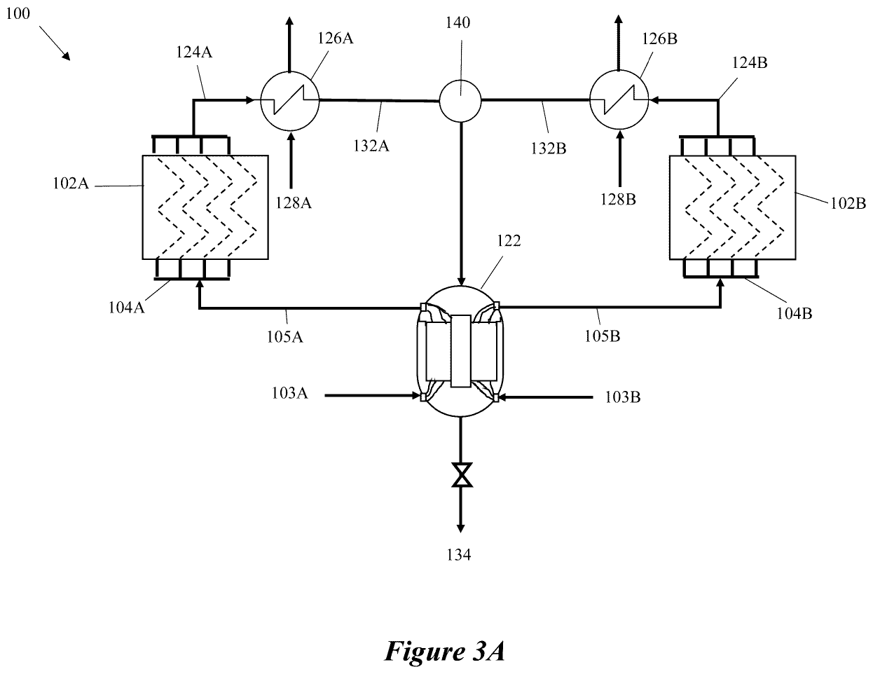

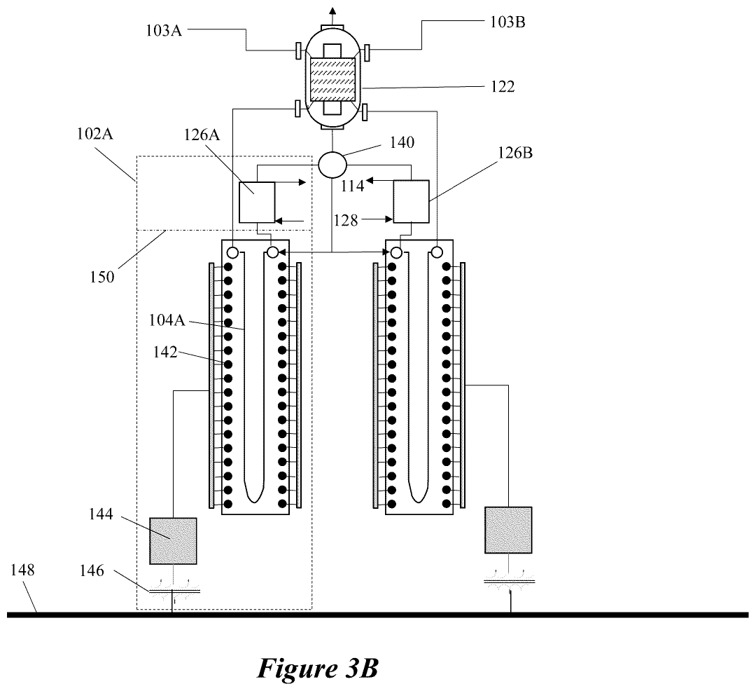

In one or more embodiments, the system 100 of FIG. 2 is suitable for use with the electric heater that is the subject of U.S. Provisional Patent Application No. 63/269,752 filed on Mar. 22, 2022, the entire contents of which are incorporated herein by reference. The electric heater described in this reference uses individual electric furnaces for each reaction coil and is heated using ceramic silicon carbide heating elements in some examples. In further implementations, it is possible to heat the feed for two or more electric furnaces against the corresponding reaction products in the secondary TLE 122, as shown and described with reference to FIG. 3A and FIG. 3B.

FIG. 3A and FIG. 3B are schematic diagrams of one or more embodiments of the system 100 of FIG. 2 with multiple electrical heaters and a common transfer line. Beginning with FIG. 3A, two separate feed streams 103A, 103B (which may both be Naptha feed stream 106, or the Naphtha dilution steam mixture 112, or some other feed) are heated in separate tube circuits of the secondary TLE 122. The separate preheated feed streams 105A, 105B are provided to separate reactor coils 104A, 104B associated with respective electrical heaters 102A, 102B to form cracked gas product flows 124A, 124B according to the processes described herein. The cracked gas flows 124A, 124B from the respective reaction 104A, 104B are minimally quenched in primary TLEs in 126A, 126B against respective BFW streams 128A, 128B. The quenched cracked gas products 132A, 132B are then mixed in a common transfer line 140 and fed, via the common transfer line 140, to a single common secondary TLE 122 for cooling against the feed streams 103A, 103B. The electrical heaters 102A, 102B may be single units, or a common group of multiple units in various embodiments. Further, the single common secondary TLE 122 may likewise provide a common effluent 134 for further processing.

In sum, the concepts of the disclosure enable separate feed streams (such as streams 103A, 103B and others described herein) to remain separated while being heated by a common cracked gas flow. Keeping the feed streams separated provides flexibility in operation of the overall system 100. Further, the secondary TLE 122 may be a single apparatus, such as a coil wound heat exchanger, that replaces two or more shell and tube heat exchangers in conventional systems and methods, which reduces costs. In some embodiments, there are any number of separate feed streams heated with a single apparatus, such as three, four, five, six, seven, eight, nine, ten, or more separate feed streams. Because of the flexibility of the system 100, any number of different configurations of feed streams, heaters, transfer lines and other features are possible. While illustration of all of the possible arrangements is not practical, such arrangements are contemplated in the present disclosure, and the disclosure is not limited solely to the arrangement shown in FIG. 3A.

FIG. 3B is a schematic plan view of the system 100 of FIG. 3A that provides further details regarding the electrical heaters described herein. As noted above, each electrical heater 102A, 102B may have an arrangement that is emphasized in FIG. 3B with a dashed box. Each electrical heater, including without limitation electrical heaters 102, 102A, 102B, includes a selected number of heating elements 142, which may be ceramic silicon carbide or some other material, arranged around a respective reactor coil 104A, 104B. The heating elements 142 are electrically connected via electrical cables to a power controller 144 associated with a transformer 146. The power controller 144 is operable to control an amount of power, or electrical energy, provided to the heating elements 142, which in turn, controls the heat output by the heating elements 142. The transformer 146 transfers electrical energy between circuits of the heater without a change in frequency. The transformer 146 and power controller 144 are connected via electrical cables to a bus 148 that may be common to multiple, or all, of the heaters and is operable to connect the heaters to a common high voltage electrical supply. In an embodiment, each heater includes a respective primary TLE 126 as part of the overall heater system, as indicated by the inclusion of a respective primary TLE 126 in the dashed box in FIG. 3B. Alternatively, the primary TLE 126 may be omitted from each heater and is instead considered a separate component, as indicated by dashed dot line 150. Such an alternative arrangement may be applicable where the electrical heaters share a common primary TLE 126, among others. Although the features of only one heater, such as electrical heater 102A, have been illustrated and described, each of the other heaters described herein may have similar features in a similar arrangement.

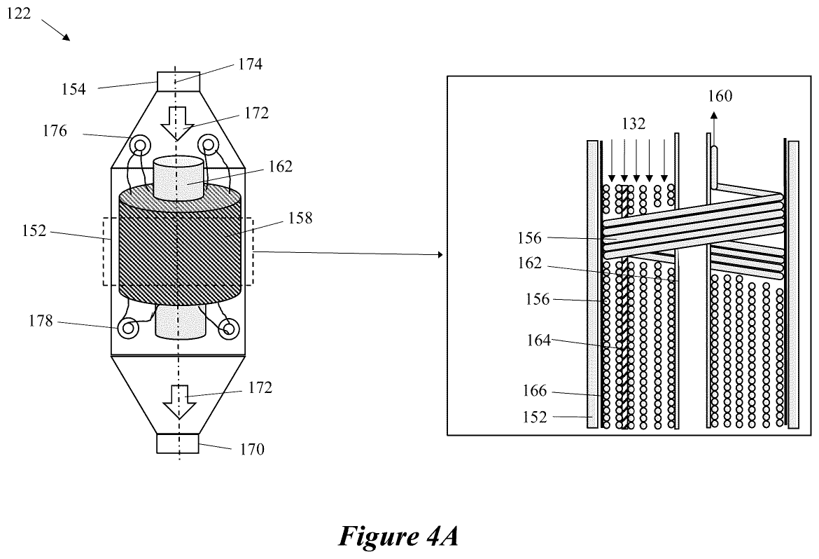

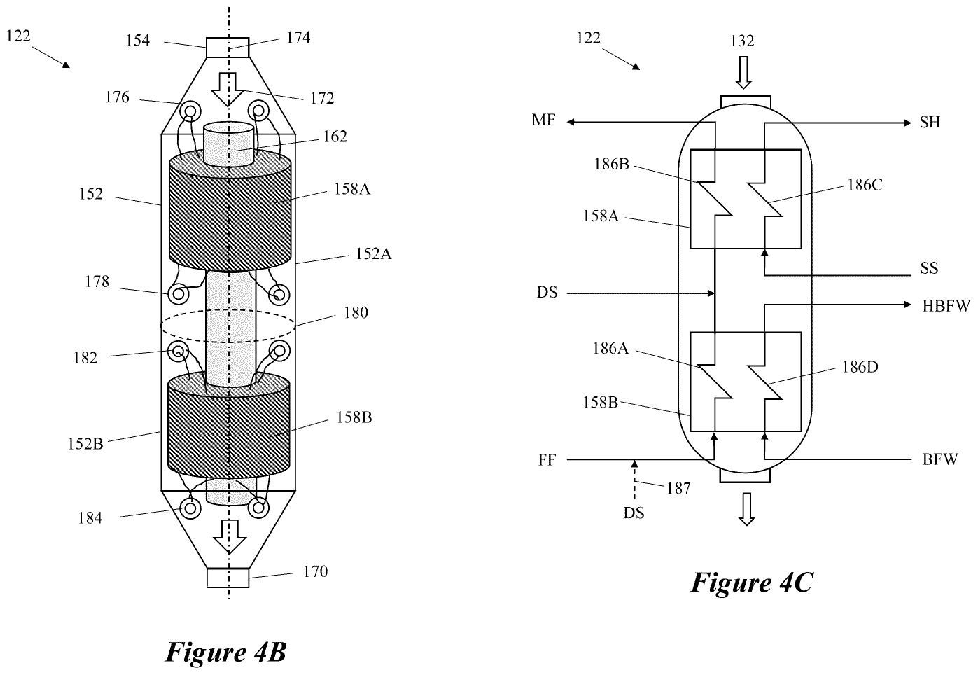

FIG. 4A is a schematic illustration providing additional detail of the secondary TLE 122 of the system 100. In an embodiment, the secondary TLE 122 is a heat exchanger, and thus FIG. 4A provides additional details of the heat exchangers contemplated in the present disclosure. In sum, the minimally quenched cracked gas 132 flows into a pressure vessel 152 or shell 152 via an inlet 154 of the shell 152. The minimally quenched cracked gas 132 flows around the outside of tubes 156 (i.e., the “shell side” of the secondary TLE 122) contained in a wound coil type bundle 158 or coiled tube bundle 158 inside the shell 152. The tubes 156 in the coiled tube bundle 158 contain fluid 160 to be heated, which may be process fluid such as hydrocarbon plus dilution steam (or the Naptha dilution steam mixture 118 in a non-limiting example), among others. The tubes 156 are wound in concentric layers around a central mandrel 162 and separated by spacer bars or rods 164. A shroud 166 is provided to surround and support the tube bundle 158, and to direct the cracked gas flow across the tubes 156. The tubes 156 are shown schematically in both side elevational view as well as cross-sectional view in the detailed image of FIG. 4A to demonstrate the winding angle of the tubes 156 about the mandrel 162, which may be any angle between 0 degrees (i.e., greater than 0 degrees) up to and including 20 degrees relative to a horizontal reference plane through a vertical mandrel 162) as well as the axial and radial spacing of the tubes 156 in the coiled tube bundle 158. As a result, the minimally quenched cracked gas 132 flowing around the outside of the tubes 156 transfers heat via indirect heat transfer to the fluid 160 inside the tubes 156 to provide the benefits described herein.

In more detail, the secondary TLE 122 includes the shell 152, which may be an outer shell 162 that may generally be arranged vertically as shown in FIG. 4A, although other configurations are contemplated. In more detail, the secondary TLE 122 is arranged vertically in a preferred embodiment, meaning that a longest dimension of the second TLE 122, which is typically the length, is arranged at a right angle to a horizontal plane or that a top of the secondary TLE 122 is directly above the bottom according to the ordinary meaning of “top” and “bottom.” In some embodiments, the secondary TLE 122 may be arranged horizontally, meaning that the longest dimension of the TLE 122 is perpendicular to vertical or arranged parallel to the plane of the horizon. The shell 152 includes the inlet 154 and an outlet 170 to define a flow path through the shell 152 that is generally indicated by arrows 172. Further, the shell 152 has a longitudinal axis 174 that may be a vertical centerline through the shell 152 with the inlet 154 and the outlet 170 centered on the axis 174. The coiled tube bundle 158 is arranged inside the shell 152 with the tubes 156 in concentric layers around the mandrel 162, as noted above. The mandrel 162 may be aligned with the longitudinal axis 174 such that the coiled tube bundle 158 and the tubes 156 are likewise centered on the longitudinal axis 174. The coiled tube bundle 158 is connected to tube sheets 176, 178 to achieve the flow schemes described herein, and in particular, to assist with defining the tube circuits for heating of different fluids. Although not shown, the tube sheets 176, 178 may define an inlet and outlet for the flow of the process fluid through the tubes 156 of the bundle 158 such that the tube sheets 176, 178 may convey fluid or process streams to, through, and away from the coiled tube bundle 158 to recover heat from the minimally quenched cracked gas 132 along the flow path 172 via indirect heat transfer.

FIG. 4A also provides a representation of the winding angle of the tubes 156 of the coiled tube bundle 158. The overall length of the tubes 156 can be varied independent of a diameter of the shell 152 by adjusting the winding angle of the tubes 156 relative to a horizontal plane through the shell 152. For example, reducing the winding angle relative to horizontal increases tube density and tube length. Although the scale of FIG. 4A shows minimal spacing between the tubes 156, there may be axial spaces (i.e., in a vertical direction) between the concentric layers to increase contact surface area of the minimally quenched cracked gas 132 with the tubes 156. More specifically, the tubes 156 may have a first spacing in a radial direction perpendicular to the longitudinal axis 184 that is greater than a second spacing in an axial direction Y parallel to, and aligned with, the longitudinal axis 174.

In some embodiments, the first spacing is on average 10 times greater, or more, than the average of the second spacing. Thus, a ratio of the first spacing to the second spacing may be expressed as >10:1. The average spacings between the tubes 156 in each bundle of coiled tubes 148 is significant because the reduction in pressure drop achievable with the secondary TLE 122 is at least partially attributable to flowing the quenched reaction products 132 on the outside of a structure with relatively large radial spacing between layers. In other words, the specific spacing described herein enables a further reduction in pressure drop by providing a large radial spacing between tubes 156 that does not impede the flow of the reaction products 132 through the secondary TLE 122 or otherwise substantially change the direction of the flow of reaction products 132 through the secondary TLE 122. The comparatively smaller second spacing increases surface area of the tubes 156 in contact with the reaction products 132 to improve heat transfer, while also not being large enough to change the direction of the flow of the reaction products 132 substantially away from the longitudinal axis 174. As a result, the spacings between tubes 156 provides further benefits and advantages relative to conventional transfer line exchangers and heat exchangers.

FIG. 4A is a non-limiting example of a secondary TLE 122 with a single coiled tube bundle 158. The secondary TLE 122 may also have more than one coiled tube bundle 158, such as at least two coiled tube bundles 158A, 158B, as in FIG. 4B. In one or more embodiments, a plane 180 passes through the shell 152 and the axis 174. In an embodiment, the plane 180 is a horizontal plane through the shell 152 that intersects the longitudinal axis 174 through the shell 152 such that the plane 180 is perpendicular to the axis 174. The plane 180 separates the shell 152 into a first portion 152A and a second portion 152B and may be a conceptual dividing line of the shell 152 to provide additional context regarding concepts of the disclosure. In practice, the shell 152 is a single, integral, unitary component with a continuous body including the first and second portions 152A, 152B. In an embodiment, the first and second portions 152A, 152B are separate cylindrical sections of different diameters that are separated by and connected to each other with a transition piece with a tapering or changing diameter to connect the two sections. The first portion 152A of the shell 152 is an upper portion of the shell 152 on a first or upper side of the plane 152 and the second portion 152B of the shell 152 is a lower portion of the shell 152 on a second or lower side of the plane 180 opposite to the first side.

Further, the inlet 154 leads into the first portion 152A of the shell 152 and the second portion 152B leads to the outlet 170 of the shell 152. As a result, the flow path 172 through the shell 152 traverses the inlet 174, the first portion 152A of the shell 152, the second portion 152B of the shell 152, and the outlet 170 in sequential order. The flow path 172 thus follows the longitudinal axis 174 of the shell 152 without a substantial change in direction of fluid or effluent (such as minimally quenched cracked gas 132, or others) along the flow path 172. The secondary TLE 122 also includes a first heat transfer surface and a second heat transfer surface, which may be a first coiled tube bundle 158A and a second coiled tube bundle 158B, respectively. Further, the plane 180 may be a reference surface across which all of the effluent flows without a substantial change in direction. The first coiled tube bundle 158A is arranged in the first portion 152A of the shell 152, while the second coiled tube bundle 158B is arranged in the second portion 152B of the shell 152. The first and second tube bundles 158A, 158B are illustrated schematically in FIG. 4B as cylinders, but in practice, the first and second heat tube bundles 158A, 158B may include the features shown and described with respect to the detail view of FIG. 4A. In one or more embodiments, the first and second coiled tube bundles 158A, 158B may be distinct coiled tube bundles each containing a respective plurality of coiled tubes 156 arranged around a single mandrel 162 with the respective coiled tube bundles 158A, 158B spaced from each other along the mandrel 162. The secondary TLE 122 may also include additional tube sheets 182, 184 corresponding to the additional coiled tube bundle 158B. Similar to tube sheets 176, 178, the tube sheets 182, 184 assist with defining the flow path for process fluids to, through, and away from the tubes 156 of the coiled tube bundle 158B. In other words, the tube sheets 176, 178, 182, 184 assist with defining the tube circuits described herein.

In sum, FIG. 4B provides an arrangement of the secondary TLE 122 with two coiled tube bundles 158A, 158B in series along the longitudinal axis 174 with a common cracked gas flow, or common flow of quenched reaction products 132. The arrangement of FIG. 4B provides even more flexibility to the system 100 by enabling, in some non-limiting examples: (i) preheating of feeds with different inlet temperatures; (ii) preheating BFW in the lower bundle 158B to increase steam generation; or (iii) pre-heating other service fluids, such as for example diathermal oil, for further downstream needs, among others. Such an arrangement might be particularly advantageous for a cracker system with a gaseous feed such as propane or ethane, since the cracked gas can be cooled to a low temperature before the reaction products condense and cause fouling and blockages.

The arrangement of the secondary TLE 122 (or heat exchanger 122) in FIG. 4A and FIG. 4B has a number of advantages over known transfer line exchangers and heat exchangers. In particular, the coiled tube bundle 158 (or tube bundles 158A, 158B) can cool the quenched reaction products 132 along the flow path 172 to a desirable temperature without separate downstream cooling units and without deviating a direction of flow of the products 132 substantially away from the longitudinal axis 174. As a result, there is a significantly lower pressure drop in the cracked gas reaction products 132 through the secondary TLE 122 relative to flowing the reaction products 132 on the tube side (i.e., through tubes 156). The reduction in pressure drop minimizes compression costs and also improves reactor yields for chemical reaction selectivity that favors lower pressures. The pressure drop reduction is attributable, at least in part, to cooling the reaction products 132 on the shell side (i.e., outside the tubes 152), which eliminates piping to pass cooled reaction products 132 from the secondary TLE 122 to effluent coolers and the pressure drop associated with entrance loss, bends, and tees for distributing the flow.

Further, the plot space and capital costs associated with the secondary TLE 122 are significantly reduced relative to known transfer line exchangers and heat exchangers. Such benefits are particularly pronounced for cracked gas effluent at low pressures that utilize large pipework, such as pipes with diameters of 20 inches or larger. Finally, the tubes bundles 158, 158A, 158B operate in series as separate heat recovery or cooling circuits in different sections of the secondary TLE 122 with operation capacity that can be varied according to operational duty of the systems incorporating the secondary TLE 122. In other words, coolant capacity through each bundle 158, 158A, 158B may be adjusted in response to operational characteristics of the larger processing system, which optimizes heat transfer and enables more efficient processing applications that are responsive to changing demands in a broader system.

The secondary TLE 122 overcomes many of the deficiencies and disadvantages of known heat exchangers discussed herein. For example, a single shell 152 may provide, via coiled tube bundles 158, 158A, 158B, indirect heat transfer that preheats feed or other processing fluids in the absence of a convection section, or where heat duty for the convection section is insufficient, such as with a low emission furnace. The use of a single shell 152 eliminates a significant amount of pipework and support structures associated with connecting and supporting multiple heat exchangers in series and parallel as in the known systems described herein. As noted above, the tube length in the secondary TLE 122 can be varied independent of the shell diameter by adjusting the winding angle. The secondary TLE 122 is therefore more compact, with higher overall heat transfer coefficient than known heat exchangers. The surface area utilized for cooling is less than an equivalent shell and tube exchanger and in some embodiments, the surface area of the coiled tube bundles 158, 158A, 158B may be approximately a third of the surface area in known heat exchangers. In addition, large capacity or operational duty can be accommodated in a single train.

The lowest pressure drop may occur on the shell side for flow of the quenched reaction products 132 around the tubes 156. By placing the colder feed in the tubes 156, the hot end tubesheet temperature is reduced, which effectively reduces the maximum metal design temperature by the same amount, thereby enabling a higher heat recovery within a constraint of maximum temperature (due to materials limits or concern of coking deposits) than could be achieved if the reaction products 132 were placed in the tubes. The layers of tubes 156 also form “passages” for the vapor flow, which are relatively large. The spacing of the tubes 158 described herein minimizes the risk of blockage and provides a relatively large open area normal to the flow, which may enable flow through the layers without a substantial change in direction of the flow of the reaction products 132, as described herein.

Unless the context dictates otherwise, “without substantial change in direction,” when describing a direction of flow of the quenched reaction products 132, means that the bulk flow of the quenched reaction products 132 is primarily between the layers of coiled tubes 152 and is parallel to the axis 174, understanding that there may be minor deviations affecting 10% of the bulk total fluid flow or less, or more preferably 5% or less, due to components such as temperature devices or other protuberances that do not significantly affect the direction of the bulk flow. In addition, changes in cross-sectional area of the bulk flow are not considered to be “substantial changes in direction” or deviations from the direction of the bulk flow, so long as the changes in cross section retain a common longitudinal axis. Changes in flow direction at a small scale (i.e., less than a diameter of a single tube 156) due to turbulence or the turbulent nature of the flow are not considered “substantial changes in direction” or deviations from the longitudinal axis since they do not affect the overall bulk direction of the flow. In at least some examples, “without substantial change in direction,” when describing a direction of flow of the quenched reaction products 132, means that at least 90% of the bulk flow, or more preferably at least 95% of the bulk flow, is parallel to, or within an acceptable range of deviation from parallel (i.e., within 3 degrees of parallel), to the longitudinal axis 174. In some embodiments, “without a substantial deviation from the longitudinal axis” may have a similar meaning to “without substantial change in direction” provided above.

FIG. 4C is a schematic illustration of tube circuits in the secondary TLE 122. With reference to FIG. 4A-4C, the quenched reaction products 132 are fed to the inlet 174 of the secondary TLE 122. The secondary TLE 122 may include two coil wound tube bundles 158A, 158B in series with the tube sheets 176, 178, 182, 184 cooperating with the tubes 156 to define one or more tube circuits in each of the bundles 158A, 158B. For example, each of the bundles 158A, 158B may include two tube circuits in one or more embodiments. The common quenched reaction product 132 flow (or cracked gas flow) is cooled against multiple streams in the different tube circuits. In a first tube circuit 186A in the second coil wound bundle 158B, feed gas (FF) is heated (or preheated) against the reaction product flow 132. Dilution steam (DS) is then added to the heated feed gas (FF). In an embodiment, the dilution steam (DS) is instead mixed with the feed gas (FF) outside of, or external to, to the shell 152, as indicated by dashed arrow 187. In a second tube circuit 186B in the first coiled tube bundle 158A, the feed and dilution steam mixture MF is further heated against the reaction products 132 and output for further processing, such as to the heater or furnace. The first and second circuits 186A, 186B may be arranged with an inlet tube sheet on a first or left side of the secondary TLE 122 with the inlet tube sheet associated to the second circuit 186B vertically above the inlet of the first circuit 186A relative to the axis 174. Further, the first and second circuits are arranged in series to define a single path for fluid flow.

In one or more embodiments, boiler feed water (BFW) is heated against the flow of reaction products 132 in a third tube circuit 186C in the second coiled tube bundle 158B and output as heated boiler feed water (HBFW). In a fourth tube circuit 186D in the first coiled tube bundle 158A, saturated steam (SS) is superheated against the flow of reaction products 132 and output as superheated saturated steam (SH). Other configurations are possible, including heating of the feed (FF) and/or feed and dilution steam mixture (MF) in only a single tube circuit instead of two circuits 186A, 186B in series, as well as heating of other process fluids, such as at least diathermal oil in one of the circuits 186A, 186B, 186C, 186D instead of the above-referenced fluids, or in a different, fifth circuit. In addition, the tube sheets 176, 178, 182, 184 may define more or less than four total circuits with more or less than two circuits per bundle 158A, 158B in some embodiments. In an embodiment, an outlet tube sheet is common to at least two of the circuits 186A, 186B, 186C, 186D so that two separate feeds enter circuits separately, but exit from the same outlet tubesheet to provide additional flexibility in the arrangement of the circuits 186A, 186B, 186C, 186D. In a further embodiment, a common feed splits to two or potentially more separate tubesheets so that a common feed stream is distributed to different circuits 186A, 186B, 186C, 186D to provide yet further flexibility. In this way, the concepts of the disclosure are capable of heating more than one process stream, including preheating one or more feed streams, simultaneously in a single heat exchange device via indirect heat transfer that does not utilize a convection section as in conventional technologies.

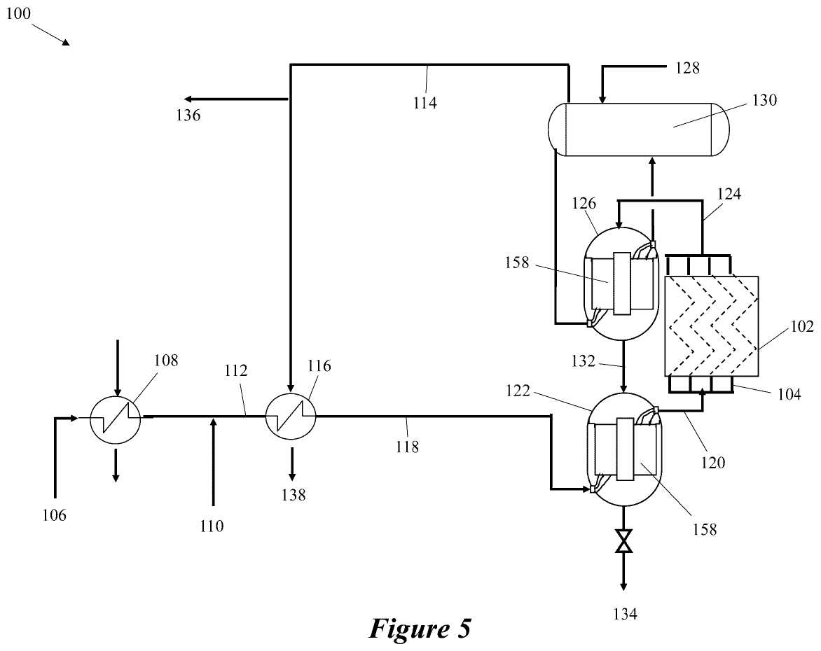

FIG. 5 is a schematic diagram of an embodiment of the heat recovery system 100 where the primary TLE 126 and secondary TLE 122 both include coiled tube bundles. Although the concepts of the disclosure may be particularly advantageous for use with a secondary heat exchanger after an initial quench to freeze the reaction products, the disclosure contemplates the use of a heat exchanger with one or more coiled tube bundles, such as the type described at least with reference to FIGS. 4A-4C, as both the primary and second heat exchangers or primary and secondary TLEs 126, 122. Other configurations may be possible, such as the primary TLE 126 being a heat exchanger with a coiled tube bundle while the secondary TLE 122 is a conventional device.

Quench cooling is an important aspect for the reaction yield and product quality and is usually carried out separately for each individual coil of the reactor to minimize residence time. However, the disclosure is not limited to such a use of a conventional quench cooler. The use of a heat exchanger with a coiled tube bundle as a primary TLE cooler for cracked gas effluent in direct fluid communication with the cracking heater is contemplated herein. In such an example, the inlet to the primary TLE 122 may be designed to minimize residence time and avoid eddies and backmixing. In FIG. 5, the cracked gas 124 leaving the reaction coils 104 is cooled against boiling water in the coiled tube bundle 158 of the primary TLE 126. The quenched cracked gas 132 is then fed to the secondary TLE 122 where it is further cooled against the reaction feed (or heated Naphtha dilution steam mixture 118). The cooling of the quenched cracked gas 132 against the mixture 118 heats the mixture 118 via indirect heat transfer to increase the crossover temperature TXO of the further heated mixture 120 that is provided from the secondary TLE 122 to the reactor coils 104 and heater 102. Despite the primary and secondary TLEs 126, 122 being illustrated as separate devices in FIG. 5, the primary and secondary TLEs 126, 126 can be combined in a single vessel or shell in some embodiments (i.e., a single TLE). The primary TLE 126 with one or more coiled tube bundles 158 likewise does not flow the cracked gas reaction product 124 through the inside of a straight tube, but rather, flows the reaction product 124 around the outside of the tubes in the shell side space, as described above for the secondary TLE 122. Such an arrangement avoids the need for cooling of a tubesheet or other structure at the location where the cracked gas 124 transitions from the inlet region to the cooled region of the primary TLE 126, which would be the case for a conventional primary TLE as described in more detail in reference Ullmans Encyclopaedia-“Ullmann's Encyclopaedia of Industrial Chemistry”, 15 Apr. 2009, article “Ethylene,” Section 5.2. As such, the concepts of the disclosure are not limited only to secondary heat exchangers after an initial quench, but rather, also include a heat exchanger apparatus for the initial cooling or quenching step as a primary heat exchanger. Further, the disclosure is not limited to the use of separate vessels for the primary and secondary heat exchange aspects given that both the primary and secondary TLE could be combined in a single vessel.

The system 100 provides flexibility in design that yields a number of other configurations and variations than those described herein, such as: (a) a portion of the dilution steam heated separately in a dedicated tube circuit alongside the hydrocarbon feed; (b) diathermal oil tube bundles can be included in parallel or in series and pre-heated diathermal oil can be used downstream for further process requirements; (c) in turn-down cases or when only some heaters are working, the unused feed coils may be used for other purposes; and/or (d) the concepts of the disclosure can be adapted to other reactions where fired heating duty is replaced with electrical heating, or in other words, to other applications where a convection section is not utilized or where the convection section does not provide sufficient heat duty for heating the reactor feed, among many others.

In summary, the concepts of the disclosure do not utilize shell and tube heat exchangers with straight tubes and do not utilize steam as an intermediate fluid in a convection section. While the concepts of the disclosure do not necessarily preclude the use of steam generated by quench cooling to partially provide heating for other areas of the system or method, such as for example, quench cooling steam used to preheat a liquid naphtha feed following vaporization as described herein, the disclosure minimizes or eliminates steam generated by quench cooling in favor of indirect heat exchange with the reactor feed. In embodiments where the system is a hybrid system with both fuel fired and electrically heated furnaces, the amount of heat available from the cracked gas may in fact exceed the preferred heat duty to preheat the feed because there is additional heat available from the flue gas in the fired portion. In such embodiments, some tube circuits may be dedicated to: (1) superheating steam either prior to expansion in a steam turbine to generate shaft work; (2) to superheat dilution steam which can be mixed with hydrocarbon feeds to provide optimum steam to oil ratio; (3) to preheat air which can then be used to reduce fuel consumption in the fired portion; or (4) to pre-heat any other service fluid such as hot oil for further downstream processing.

In addition, the concepts of the disclosure provide devices, systems, and methods for performing subsequent cooling steps in a single apparatus (shell) rather than in multiple steps (multiple shells). As described herein, the system 100 can heat multiple feeds simultaneously against a combined cracked gas flow in a single shell, which reduces the equipment count and provides other advantages over known systems and methods. The concepts of the disclosure do not utilize fired heat from the reactor byproducts to preheat the hydrocarbon feed streams. Instead, the feed streams are heated by indirect heat exchange with the reaction products. The reactor by products may then be available to heat other non-electrically heated furnaces. The indirect heat exchange contemplated in the disclosure also does not produce any inherent emissions.

Because the cracked gas flows along a substantially continuous path in a shell side space around tubes and the tubes define tube circuits connected to inlet and outlet tube sheets, the coiled tubes can expand and contract without imparting a significant load on the connecting tube sheets and no bellows is utilized. The disclosure contemplates coiled tubes around a central mandrel to provide continuous passages for the cracked gas flow without substantial changes in direction and omits baffles and other flow control devices in conventional technologies that lead to undesirable pressure losses, eddies, backmixing and potential for fouling and/or blockage. Each tube circuit can be used for the same process fluid or for different process fluids to be heated such as steam or different feedstock to individual reactor coils. Further, while the concepts of the disclosure can be utilized to quench the reaction products by indirect heat exchange with feed streams, it may be preferred to initially quench reaction products by generating steam since this provides a short residence time at high temperature to improve reaction yield and product quality. According to the disclosure, the amount of quench cooling is minimized such that the reaction products leave the quench cooler at a high temperature in the range of 550-700 degrees C. (depending on the feedstock used, this is considered to be the temperature at which the reaction products are “frozen”) and subsequent cooling is done in a vessel containing a wound coil heat exchanger bundle.

The concepts of the disclosure reduce the total surface area utilized for heat recovery from cracked gas by over 50% relative to conventional devices, systems, and methods with cracked gas flow inside the tubes (i.e., on the tubeside), which reduces materials costs as well as piping, structure and installation costs. Further, the concepts of the disclosure provide a more robust construction with respect to mechanical loads caused by thermal expansion of the tubes and/or the tubes relative to the shell such that a bellows device is not necessary to compensate for thermal loads arising from differential thermal expansion between the tubes and the shell.

Improved performance is enabled by the feed being heated to a higher temperature (higher crossover temperature TXO) than with conventional straight tube shell and tube type heat exchangers, or other known heat exchangers, thereby reducing the amount of external energy used to preheat feed streams in the reactor coils. This advantage arises because the straight tubes used in conventional designs have an inherent limit on the heat transfer rate for a given pressure drop that cannot be overcome by adding additional tubes since the addition of tubes reduces the average velocity per tube and therefore the film heat transfer coefficient. Once the maximum tube length (based on fabrication or other mechanical limits) is set, so is the effective maximum heat recovery. The same limitations do not apply to the wound coil heat exchangers contemplated in the disclosure. The tubes may be wound at a larger or smaller angle to increase the tube length independent of the shell side flow length. In this way, the heat transfer resistance can be minimized on both sides, leading to an overall reduction in the surface area required. It has been discovered that the area occupied by a coil wound heat exchanger of the type contemplated herein is between 0.25 to 0.5 times the area occupied by a conventional shell and tube heat exchanger (i.e., with straight tubes).

Further, the concepts of the disclosure provide multiple tube circuits so that a single combined effluent stream from multiple reactor coils can be used to heat different feedstock and/or ancillary fluids in series or in parallel, such as steam, process (dilution) steam, boiler feedwater or diathermal oil, among others. The heat exchangers contemplated herein can be divided into two bundles in series while maintaining a continuous flow path for the cracked gas or reactor effluent without a significant change in direction, as that term is defined herein. Heating multiple separate feeds to a steam cracker in a common shell has numerous advantages for operating with mixed or variable feedstocks, as well as reducing piping costs, among other benefits and advantages described herein.

In view of the above, one or more embodiments of a system may be summarized as including: a heater; a reactor coil in communication with (i.e., contained within, or heated by) the heater and configured to output a reaction product stream; a primary heat exchanger in communication with the reactor coil and configured to cool the reaction product stream to form a quenched reaction product stream; and a secondary heat exchanger in communication with the primary heat exchanger, the secondary heat exchanger including at least one coiled tube bundle configured to heat a feed stream against the quenched reaction product stream from the primary heat exchanger via indirect heat transfer to form a heated feed stream.

In an embodiment, the heater is at least one of an electrical heater and a low emission furnace.

In an embodiment, the at least one coiled tube bundle of the secondary heat exchanger further includes: a mandrel; a plurality of coiled tubes in concentric layers around the mandrel; and at least one tube sheet coupled to the plurality of tubes, wherein the quenched reaction product flows around an outside of the plurality of coiled tubes and the feed stream flows inside of the plurality of coiled tubes to heat the feed stream via indirect heat transfer against the quenched reaction product stream.

In an embodiment, the quenched reaction product flows around the outside of the plurality of coiled tubes without a substantial change in direction from an inlet to an outlet of the secondary heat exchanger.

In an embodiment, the at least one coiled tube bundle of the secondary heat exchanger includes a plurality of tubes coiled in concentric layers, and the quenched reaction product flows around an outside of the plurality of coiled tubes.

In an embodiment, the at least one coiled tube bundle includes a first coiled tube bundle and a second coiled tube bundle arranged in series in the secondary heat exchanger.

In an embodiment, the first coiled tube bundle and the second tube bundle are associated with respective tube sheets to define at least two tube circuits through each of the first coiled tube bundle and the second tube bundle.

In an embodiment, a first tube circuit of the second coiled tube bundle and a second tube circuit of the first coiled tube bundle are arranged in series and configured to heat the feed stream against the quenched reaction product stream.

In an embodiment, a third tube circuit of the first coiled tube bundle and a fourth tube circuit of the second coiled tube bundle are arranged in parallel and each configured to heat one of a plurality of process streams against the quenched reaction product stream.

In an embodiment, the plurality of process streams include boiler feed water, saturated steam, and diathermal oil.

In an embodiment, the primary heat exchanger includes at least one coiled tube bundle.

In an embodiment, a temperature of the heated feed stream output from the secondary heat exchanger to the reactor coil is in a range between and including 500 degrees C. to 650 degrees C., a temperature of the reaction product stream exiting the reactor coil is in a range between and including 750 degrees C. to 875 degrees, and a temperature of the quenched reaction product stream output from the primary heat exchanger to the secondary heat exchanger is in a range between and including 550 degrees C. to 700 degrees C.

One or more embodiments of a system may be summarized as including: a heater; a reactor coil in communication with the heater and configured to output a reaction product stream; a primary heat exchanger in communication with the reactor coil and configured to cool the reaction product stream to form a quenched reaction product stream; and a secondary heat exchanger in communication with the primary heat exchanger, the secondary heat exchanger including a shell, at least one coiled tube bundle inside the shell, the at least one coiled tube bundle including a mandrel and a plurality of coiled tubes arranged in concentric layers around the mandrel, at least one tube sheet coupled to the plurality of tubes, wherein the quenched reaction product stream flows through a shell side of the secondary heat exchanger and the feed stream flows through a tube side of the secondary heat exchanger to heat the feed stream via indirect heat transfer against the quenched reaction product stream and form a heated feed stream.

In an embodiment, the plurality of coiled tubes of the at least one coiled tube bundle and the at least one tube sheet cooperate to define a plurality of tube circuits, a first one of the plurality of tube circuits configured to heat the feed stream against the quenched reaction product stream and a second one of the plurality of tube circuits configured to heat a process stream against the quenched reaction product stream.

In an embodiment, the process stream is one of boiler feed water, saturated steam, or diathermal oil.

In an embodiment, the heater is an electrical heater or a low emissions furnace, or both, and the primary heat exchanger includes at least one coiled tube bundle.

In an embodiment, the heater includes a plurality of heaters, the reactor coil is one of a plurality of reactor coils each associated with a respective one of the plurality of heaters, and the primary heat exchanger is one of a plurality of primary heat exchangers associated with respect ones of the plurality of reactor coils, the secondary heat exchanger configured to heat separate feed streams for the plurality of reactor coils via indirect heat transfer against a combined quenched reaction product stream from the plurality of primary heat exchangers in a single vessel.

In an embodiment, the quenched reaction product stream flows through the shell side without a substantial change in direction.

In an embodiment, a temperature of the heated feed stream output from the secondary heat exchanger to the reactor coil is in a range between and including 400 to 700 C and preferably 500 degrees C. to 650 degrees C.

In an embodiment, a temperature of the reaction product stream exiting the reactor coil is in a range between and including 750 degrees C. to 875 degrees.

In an embodiment, a temperature of the quenched reaction product stream output from the primary heat exchanger to the secondary heat exchanger is in a range between and including 550 degrees C. to 700 degrees C.

In an embodiment, the reaction product stream is a cracked gas stream and the quenched reaction product stream is a quenched crack gas stream.

Embodiments also include methods according to any of the above non-limiting embodiments.

One or more embodiments of a method may be summarized as including: partially cooling a cracked gas product from one or more reactor coils with a primary heat exchanger against boiling water from a first temperature in a range between and including 700 degrees C. to 875 degrees C. to a second temperature in a range between and including 550 degrees C. to 700 degrees C. to form a quenched cracked gas product with the second temperature; feeding the quenched cracked gas product to an inlet of a second heat exchanger containing at least one coiled tube bundle with a plurality of tube circuits; preheating a feed stream to the one or more reactor coils against the quenched crack gas product in at least a first one of the plurality of tube circuits to a third temperature in a range between and including 500 degrees C. to 650 degrees C. to form a preheated feed stream with the third temperature; heating one or more process streams in at least a second one of the plurality of tube circuits; and further heating the preheated feed stream with the one or more reactor coils to form the cracked gas product in an open fluid loop.

In an embodiment, the preheating the feed stream includes flowing the quenched cracked gas product around an exterior of the at least one coiled tube bundle and flowing the feed stream inside the at least the first one of the plurality of tube circuits.

In an embodiment, the heating of one or more process streams includes flowing the one or more process streams inside the at least the second one of the plurality of tube circuits and heating the one or more process streams via indirect heat transfer with the quenched cracked gas product flowing around the exterior of the least one coiled tube bundle.

In an embodiment, the preheating the feed stream and the heating the one or more process steams occur simultaneously in a single shell of the secondary heat exchanger.

In an embodiment, the primary heat exchanger includes at least one coiled tube bundle.

In an embodiment, the one or more process streams include one or more of boiler feed water, saturated steam, and diathermal oil.

In an embodiment, the at least one coiled tube bundle of the secondary heat exchanger further includes: a mandrel; a plurality of coiled tubes arranged in concentric layers around the mandrel; and at least one tube sheet coupled to the plurality of tubes, the at least one tube sheet and corresponding ones of the plurality of tubes cooperating to define the plurality of tube circuits.

In an embodiment, the further heating of the preheated feed stream includes heating with an electric heater or a low emission furnace, or both.

One or more embodiments of a method may be summarized as including heating separate fluid streams simultaneously against a reactor effluent with at least one coiled tube bundle of a single heat exchanger.

One or more embodiments of a device may be summarized as including a single heat exchanger with at least one coiled tube bundle configured to heat one or more fluid streams against a common reactor effluent, the common reactor effluent flowing around an outside of the at least one coiled tube bundle, and the one or more fluid streams flowing through one or more tube circuits in the at least one coiled tube bundle.

The above description of illustrated embodiments, including what is described in the Abstract, is not intended to be exhaustive or to limit the implementations to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied outside of the heat exchanger context, and are not limited to the example heat exchanger systems, methods, and devices generally described above.

Many of the methods described herein can be performed with variations. For example, many of the methods may include additional acts, omit some acts, and/or perform acts in a different order than as illustrated or described.

In the above description, certain specific details are set forth in order to provide a thorough understanding of various embodiments of the disclosure. However, one skilled in the art will understand that the disclosure may be practiced without these specific details. In other instances, well-known structures associated with heat recovery and heat exchanger devices, systems, and methods have not been described in detail to avoid unnecessarily obscuring the descriptions of the embodiments of the present disclosure.

Certain words and phrases used in the specification are set forth as follows. As used throughout this document, including the claims, the singular form “a”, “an”, and “the” include plural references unless indicated otherwise. Any of the features and elements described herein may be singular, e.g., a shell may refer to one shell. The terms “include” and “comprise,” as well as derivatives thereof, mean inclusion without limitation. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Other definitions of certain words and phrases are provided throughout this disclosure.

The use of ordinals such as first, second, third, etc., does not necessarily imply a ranked sense of order, but rather may only distinguish between multiple instances of an act or a similar structure or material.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other derivatives thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Generally, unless otherwise indicated, the materials for making the invention and/or its components may be selected from appropriate materials such as composite materials, ceramics, plastics, metal, polymers, thermoplastics, elastomers, plastic compounds, and the like, either alone or in any combination.

The foregoing description, for purposes of explanation, uses specific nomenclature and formula to provide a thorough understanding of the disclosed embodiments. It should be apparent to those of skill in the art that the specific details are not required in order to practice the invention. The embodiments have been chosen and described to best explain the principles of the disclosed embodiments and its practical application, thereby enabling others of skill in the art to utilize the disclosed embodiments, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

The terms “top,” “bottom,” “upper,” “lower,” “up,” “down,” “above,” “below,” “left,” “right,” and other like derivatives take their common meaning as directions or positional indicators, such as, for example, gravity pulls objects down and left refers to a direction that is to the west when facing north in a Cardinal direction scheme. These terms are not limiting with respect to the possible orientations explicitly disclosed, implicitly disclosed, or inherently disclosed in the present disclosure and unless the context clearly dictates otherwise, any of the aspects of the embodiments of the disclosure can be arranged in any orientation.

As used herein, the term “substantially” is construed to include an ordinary error range or manufacturing tolerance due to slight differences and variations in manufacturing. Unless the context clearly dictates otherwise, relative terms such as “approximately,” “substantially,” and other derivatives, when used to describe a value, amount, quantity, or dimension, generally refer to a value, amount, quantity, or dimension that is within plus or minus 5% of the stated value, amount, quantity, or dimension. It is to be further understood that any specific dimensions of components or features provided herein are for illustrative purposes only with reference to the various embodiments described herein, and as such, it is expressly contemplated in the present disclosure to include dimensions that are more or less than the dimensions stated, unless the context clearly dictates otherwise.

The present application claims priority to U.S. Provisional Patent Application No. 63/498,725 filed on Apr. 27, 2023, the entire contents of which are incorporated herein by reference.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the breadth and scope of a disclosed embodiment should not be limited by any of the above-described embodiments, but should be defined only in accordance with the following claims and their equivalents.

1. A system, comprising:
a heater;
at least one reactor coil configured to receive heat from the heater and output a reaction product stream;
a primary heat exchanger in communication with the reactor coil and configured to cool the reaction product stream to form a quenched reaction product stream; and
a secondary heat exchanger in communication with the primary heat exchanger, the secondary heat exchanger including at least one coiled tube bundle configured to heat at least one feed stream against the quenched reaction product stream from the primary heat exchanger via indirect heat transfer to form at least one heated feed stream.

2. The system of claim 1, wherein the heater is at least one of an electrical heater and a low emission furnace.

3. The system of claim 1, wherein the at least one coiled tube bundle of the secondary heat exchanger further includes:
a mandrel;
a plurality of coiled tubes in concentric layers around the mandrel; and
at least one tube sheet coupled to the plurality of tubes,
wherein the quenched reaction product flows around an outside of the plurality of coiled tubes and the feed stream flows inside of the plurality of coiled tubes to heat the feed stream via indirect heat transfer against the quenched reaction product stream.

4. The system of claim 1, wherein the at least one coiled tube bundle of the secondary heat exchanger includes a plurality of tubes coiled in concentric layers, and wherein the quenched reaction product flows around an outside of the plurality of coiled tubes.

5. The system of claim 1, wherein the at least one coiled tube bundle includes a first coiled tube bundle and a second coiled tube bundle arranged in series in the secondary heat exchanger.

6. The system of claim 5, wherein the first coiled tube bundle and the second coiled tube bundle are associated with respective tube sheets to define at least two tube circuits through each of the first coiled tube bundle and the second tube bundle.

7. The system of claim 6, wherein a first tube circuit of the second coiled tube bundle and a second tube circuit of the first coiled tube bundle are arranged in series and configured to heat the feed stream against the quenched reaction product stream.

8. The system of claim 7, wherein a third tube circuit of the first coiled tube bundle and a fourth tube circuit of the second coiled tube bundle are arranged in parallel and each configured to heat one of a plurality of process streams against the quenched reaction product stream.

9. The system of claim 8, wherein the plurality of process streams include boiler feed water, saturated steam, and diathermal oil.

10. The system of claim 1, wherein the primary heat exchanger includes at least one coiled tube bundle.

11. The system of claim 1, wherein a temperature of the heated feed stream output from the secondary heat exchanger to the reactor coil is in a range between and including 400 degrees C. to 700 degrees C., a temperature of the reaction product stream exiting the reactor coil is in a range between and including 500 degrees C. to 1400 degrees C., and a temperature of the quenched reaction product stream output from the primary heat exchanger to the secondary heat exchanger is in a range between and including 550 degrees C. to 700 degrees C.

12. A system, comprising:
a heater;
at least one reactor coil in communication with the heater and configured to output a reaction product stream;
a primary heat exchanger in communication with the at least one reactor coil and configured to cool the reaction product stream to form a quenched reaction product stream; and
a secondary heat exchanger in communication with the primary heat exchanger, the secondary heat exchanger including:
a shell;
at least one coiled tube bundle inside the shell, the at least one coiled tube bundle including a mandrel and a plurality of coiled tubes arranged in concentric layers around the mandrel; and
at least one tube sheet coupled to the plurality of tubes,
wherein the quenched reaction product stream flows through a shell side of the secondary heat exchanger and the feed stream flows through a tube side of the secondary heat exchanger to heat the feed stream via indirect heat transfer against the quenched reaction product stream and form a heated feed stream.

13. The system of claim 12, wherein the plurality of coiled tubes of the at least one coiled tube bundle and the at least one tube sheet cooperate to define a plurality of tube circuits, a first one of the plurality of tube circuits configured to heat the feed stream against the quenched reaction product stream and a second one of the plurality of tube circuits configured to heat a process stream against the quenched reaction product stream.

14. The system of claim 13, wherein the process stream is one of boiler feed water, saturated steam, or diathermal oil.

15. The system of claim 12, wherein the heater is an electrical heater or a low emissions furnace, or both, and the primary heat exchanger includes at least one coiled tube bundle.

16. The system of claim 12, wherein the heater is one of a plurality of heaters, the at least one reactor coil is one of a plurality of reactor coils each associated with a respective one of the plurality of heaters, and the primary heat exchanger is one of a plurality of primary heat exchangers associated with respect ones of the plurality of reactor coils, the secondary heat exchanger configured to heat separate feed streams for the plurality of reactor coils via indirect heat transfer against a combined quenched reaction product stream from the plurality of primary heat exchangers in a single vessel.

17. The system of claim 12, wherein a temperature of the heated feed stream output from the secondary heat exchanger to the at least one reactor coil is in a range between and including 450 degrees C. to 700 degrees C.

18. The system of claim 17, wherein a temperature of the reaction product stream exiting the at least one reactor coil is in a range between and including 500 degrees C. to 875 degrees.

19. The system of claim 18, wherein a temperature of the quenched reaction product stream output from the primary heat exchanger to the secondary heat exchanger is in a range between and including 550 degrees C. to 700 degrees C.

20. The system of claim 18, wherein the reaction product stream is a cracked gas stream and the quenched reaction product stream is a quenched crack gas stream.

21. A method, comprising:
partially cooling a cracked gas product from one or more reactor coils with a primary heat exchanger against boiling water from a first temperature in a range between and including 500 degrees C. to 875 degrees C. to a second temperature in a range between and including 550 degrees C. to 700 degrees C. to form a quenched cracked gas product with the second temperature;
feeding the quenched cracked gas product to an inlet of a second heat exchanger containing at least one coiled tube bundle with a plurality of tube circuits;
preheating a feed stream to the one or more reactor coils against the quenched crack gas product in at least a first one of the plurality of tube circuits to a third temperature in a range between and including 450 degrees C. to 700 degrees C. to form a preheated feed stream with the third temperature;
heating one or more process streams in at least a second one of the plurality of tube circuits; and
further heating the preheated feed stream with the one or more reactor coils to form the cracked gas product in an open fluid loop.

22. The method of claim 21, wherein the preheating of the feed stream includes flowing the quenched cracked gas product around an exterior of the at least one coiled tube bundle and flowing the feed stream inside the at least the first one of the plurality of tube circuits.

23. The method of claim 22, wherein the heating of the one or more process streams includes flowing the one or more process streams inside the at least the second one of the plurality of tube circuits and heating the one or more process streams via indirect heat transfer with the quenched cracked gas product flowing around the exterior of the least one coiled tube bundle.

24. The method of claim 21, wherein the preheating of the feed stream and the heating of the one or more process steams occur simultaneously in a single shell of the secondary heat exchanger.

25. The method of claim 21, wherein the primary heat exchanger includes at least one coiled tube bundle.

26. The method of claim 21, wherein the one or more process streams include one or more of boiler feed water, saturated steam, and diathermal oil.

27. The method of claim 21, wherein the at least one coiled tube bundle of the secondary heat exchanger further includes:
a mandrel;
a plurality of coiled tubes arranged in concentric layers around the mandrel; and
at least one tube sheet coupled to the plurality of tubes,
the at least one tube sheet and corresponding ones of the plurality of tubes cooperating to define the plurality of tube circuits.

28. The method of claim 21, wherein the further heating of the preheated feed stream includes heating with an electric heater or a low emission furnace, or both.

29. The method of claim 21, wherein the preheating of the feed stream to the one or more reactor coils against the quenched crack gas product includes heating an intermediate fluid against the quenched crack gas product and preheating the feed stream against the intermediate fluid.
